(19) United States
(12) Patent Application Publication
(10) Pub. No.: US 2021/0018921 A1
(43) Pub. Date: Jan. 21, 2021

(54) METHOD AND SYSTEM USING NOVEL SOFTWARE ARCHITECTURE OF INTEGRATED MOTION CONTROLS

(71) Applicant: GM GLOBAL TECHNOLOGY OPERATIONS LLC, Detroit, MI (US)

(72) Inventors: Kausalya Singuru, Ferndale, MI (US); Nikolai K. Moshchuk, Grosse Pointe, MI (US); David Andres Perez Chaparro, Ferndale, MI (US)

(73) Assignee: GM GLOBAL TECHNOLOGY OPERATIONS LLC, Detroit, MI (US)

(21) Appl. No.: 16/511,616

(22) Filed: Jul. 15, 2019

(51) Int. Cl. G05D 1/02; G05D 1/00; G06N 7/00

(52) U.S. Cl. CPC G05D 1/0212; G05D 2201/0213; G06N 7/00; G05D 1/0088

(57) ABSTRACT

Systems, methods and apparatuses for motion control for an autonomous vehicle by implementing an adaptive skeleton construct interface with models, including: a first model which uses constructs for lateral control from a set of a plurality of constructs; and a second model which uses constructs for longitudinal control from a set of a plurality of constructs; and a path reconciling module for reconciling a path based on vehicle data to validate a path for operation and for implementing one or more of a set of lateral or longitudinal controls without having to re-create another lateral control or longitudinal control set, by selecting one or more of an already created lateral or longitudinal control sets to implement one or more sets of the plurality of constructs for vehicle control.

### TECHNICAL FIELD

The present disclosure generally relates to autonomous vehicle control systems, and more particularly, the present disclosure relates to methods and systems for using a functional architecture of integrated lateral and longitudinal controls that provide adaptable software interfaces that enable increases in scope, softness, portability, and reusability of control approaches used to control an autonomous vehicle.

Vehicle control systems utilize an architecture that applies one control approach that requires software in implementation to be recompiled in each usage context or different variants of software to be used in each different variant context. The required use of different variants of software can require significant development effort and software resources. In addition, significant time can be required to create and modify interface definitions when needed and when implementing switches in path planning and control methodology.

Accordingly, it is desirable to provide improved systems, apparatus, and methods that enable switching between multiple different control approaches without having to perform the steps of recompiling the software used in each approach. Further, it is desirable to reconcile paths from external and internal path generating modules without a need for recreating an entirely new interface. Also, it is desirable to facilitate switching between a speed based or range based longitudinal control and switching between low and high path deviations in lateral maneuvers without modifications to the software used.

Furthermore, other desirable features and characteristics of the present invention will become apparent from the subsequent detailed description and the appended claims, taken in conjunction with the accompanying drawings and the foregoing technical field and background.

### SUMMARY

Systems, Methods, and Apparatuses are provided for a functional architecture of integrated lateral and longitudinal controls that provides adaptable software interfaces for vehicle control.

In an exemplary embodiment, a system for motion control for an autonomous vehicle by implementing an adaptive skeleton construct interface with different models is provided. The system includes: a first model that includes: a lateral controller to implement selective lateral controls by an adaptive path reconstruction module to select constructs for lateral control from a set of a plurality of constructs which at least include: a low speed construct, a high speed construct and a low and high path deviation; a second model that includes: a longitudinal controller to implement selective longitudinal controls by an adaptive path reconstruction module to select constructs for longitudinal control from a set of a plurality of constructs which at least include: a speed control construct, and a range control construct; a path reconciling module for reconciling a path based on vehicle data to validate a path for operation and for implementing one or more of the lateral or longitudinal controls without having to re-create another lateral control or longitudinal control, by selecting one or more from an already created set of lateral or longitudinal controls for use wherein the vehicle data at least includes: lane, trajectory, and position vehicle data; and one or more vehicle interfaces for receiving controls from the one or more already created set of lateral or longitudinal controls.

In various exemplary embodiments, the system includes the one or more sets of the plurality of constructs implemented with usage context in the lateral and longitudinal control. The path reconciling module includes: an internal and external path generating module. The system, further includes: the first and second models include library references for at least re-usability. The set of constructs are configured in adaptable interfaces for different usage contexts extracted from an analysis of an autonomous driving domain. The speed and range control construct includes one or more different control designs for usage. The system further includes: the first and second model is configured to: implement one or more different controls for switching between each different control thereby reducing memory usage and throughput while processing.

In another exemplary embodiment, a method for implementing lateral and longitudinal controls by using an adaptive construct with models for an autonomous vehicle is provided. The method includes: configuring an external processor for generating vehicle data including: at least trajectory and road data for initiating a path reconciliation and diagnostic override mode of the autonomous vehicle; configuring an adaptive path reconstruction processor to receive the vehicle data to implement a first model of a lateral control by selecting one or more constructs for lateral control from a set of a plurality of lateral constructs which include: a low speed construct, a high speed construct and a low and high path deviation construct; configuring the adaptive path reconstruction processor to receive the vehicle data to implement a second model of a longitudinal control by selecting one or more constructs for longitudinal control from a set of a plurality of longitudinal constructs which include: a speed control construct, and a range control construct; and reconciling, by the adaptive path reconstruction module, both an internal path generating module and an external path generating module by configuring a path using selective constructs of the first and second models for lateral and longitudinal vehicle control without having to re-create models for the reconciled path.

The method further includes: configuring, by the adaptive path reconstruction module, one or more constructs of the first and second models to include vehicle usage context for the lateral and longitudinal control of the autonomous vehicle. The vehicle usage context includes low speed, high speed, and high/low path deviation maneuvers. The method further includes: implementing the first and second models with library references that enable re-usability and portability. The constructs have adaptable interfaces for different usage contexts derived from the autonomous driving domain analysis. The speed and range control constructs include: different control designs implemented for different usages.

The method further includes: switching between different models of the first and second model to implement one or more different controls/functions to reduce memory and throughput while achieving better control performance.

In yet another exemplary embodiment, an apparatus with a skeleton construct for implementing lateral and longitudinal controls by an adaptive construct with models for implementing path planning in an autonomous vehicle is provided. The apparatus includes: an external processor for generating at least vehicle data including trajectory and road data for initiating a path reconciliation and diagnostic override mode of the autonomous vehicle; an adaptive path reconstruction processor to receive the vehicle data to implement a first model of a lateral control by selecting one or more constructs for lateral control from a set of a plurality of lateral constructs which include: a low speed construct, a high speed construct and a low and high path deviation construct; the adaptive path reconstruction processor to receive the vehicle data to implement a second model of a longitudinal control by selecting one or more constructs for longitudinal control from a set of a plurality of longitudinal constructs which include: a speed control construct, and a range control construct; and the adaptive path reconstruction module reconciling both an internal path generating module and an external path generating module by configuring a path using selective constructs of the first and second models for lateral and longitudinal vehicle control without having to re-create models for the reconciled path.

In various exemplary embodiments, the apparatus further includes adaptive path reconstruction module to implement one or more constructs of the first and second models to include vehicle usage context for the lateral and longitudinal control of the autonomous vehicle. The vehicle usage context includes low speed, high speed, and high/low path deviation maneuvers. The apparatus, further includes the first and second models implemented with library references that at least enable re-usability.

The constructs include adaptable controls configured for vehicle interfaces for different usage contexts derived from analysis of an autonomous driving domain. The speed and range control constructs include different control designs implemented for different usages.

### DESCRIPTION OF THE DRAWINGS

The exemplary embodiments will hereinafter be described in conjunction with the following drawing figures, wherein like numerals denote like elements, and wherein:

FIG. 1 depicts an example vehicle that includes a controller with functional architecture of integrated lateral and longitudinal controls that provides adaptable software interfaces in accordance with various embodiments;

FIG. 2 is a functional block diagram illustrating an autonomous driving system (ADS) associated with an autonomous vehicle, in accordance with various embodiments;

FIG. 3 is a diagram depicting an exemplary architecture for an adaptable skeleton constructs and model components depicting an example controller for providing lateral and longitudinal control, in accordance with various embodiments;

FIG. 4 is a diagram depicting an the exemplary architecture of an adaptable skeleton constructs and model components that includes a lateral control and a longitudinal control in accordance with various embodiments;

FIG. 5 is a block diagram depicting an exemplary logic of pseudo code for operation of a controller or path planner in accordance with various embodiments;

FIG. 6 is a diagram depicting an exemplary illustration of the use of a domain analysis to identify features and systems in accordance with various embodiments; and

FIG. 7 is a flowchart depicting an exemplary illustration of the implementation of the functional architecture of integrated lateral and longitudinal controls that provides adaptable software interfaces for vehicle control, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description. As used herein, the term “module” refers to any hardware, software, firmware, electronic control component, processing logic, and/or processor device, individually or in any combination, including without limitation: application specific integrated circuit (ASIC), a field-programmable-gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems and that the systems described herein are merely exemplary embodiments of the present disclosure.

Autonomous vehicles, which operate in complex dynamic environments, require methods that re-configure to unpredictable situations and reason in a timely manner in order to reach a level of reliability and react safely even in complex urban situations. In turn, a flexible framework of skeleton constructs with adaptable interfaces for different usage contexts is required for use in this dynamic environment. By implementing an architecture that enables combining of automated reconstructions of interfaces from path planner processors to provide control based on path validity decisions and for switching between different controller variants as described herein can be a viable option to operate in the dynamic autonomous driving domain.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

The term “variant” refers to deviations from the norm; For example, a model variant includes models with characteristics that are different than the normal model but may operate in a similar like manner. Further, the terms “internal” and “external” are used in the context of systems and processors within the adaptive skeleton architecture or outside the adaptive skeleton architecture.

The subject matter described herein discloses apparatus, systems, techniques and articles for enables switching between different control approaches which is critical for autonomous driving in different environmental conditions by reconciles paths from external and internal path-generating modules without a need for recreating interfaces and by facilitates switching between a speed-based or range-based longitudinal control, and switching between low, high path deviation lateral maneuvers without modifications to the software.

The described apparatus, systems, techniques and articles are associated with a sensor system of a vehicle as well as a controller for receiving inputs from one or more sensing devices of the sensor system in determining, planning, predicting, and/or performing vehicle maneuvers in real-time or in the near future, or in the future.

To this end, the integrated architecture provides for lateral and longitudinal controls for autonomous driving. The controls architecture which can be adapted to different path generation methods and facilitates switching between controllers based on context usage yet to stay within memory constraints. The present disclosure provides an adaptable functional architecture that is simple enough to be integrated with angle or torque based EPS interfaces and production ACC systems.

In various exemplary embodiments, the present disclosure provides skeleton constructs with adaptable interfaces for different usage contexts derived from autonomous driving domain analysis. Further, the skeleton constructs can be implemented for uses in different control designs for different usage contexts while considering internal memory constraints; and can be implemented for uses in different path planning methods for different usage contexts.

In various exemplary embodiments, the present disclosure enables automated reconstruction of interfaces from a path planner to a controller based on path validity. In addition, this architecture achieves an optimum or best performance of lateral and longitudinal controls in different usage contexts for low and high-speed contexts for lateral control, and for range and speed based contexts for longitudinal controls.

In various exemplary embodiments, the present disclosure enables switching between different controller variants, which likely reduces a memory footprint and throughput while achieving the best control performance.

In various exemplary embodiments, the present disclosure utilizes the skeleton constructs and components available in the current architecture in order to modify existing functionality such as models of the path reconciler, lateral control and longitudinal control.

Further, the skeleton constructs provide usage contexts to follow the desired path configured from an internal processor or external processor, and low speed, high speed, and low/high path deviation maneuvers. Also, range and speed control methods are provided of quality attributes that are desired for path attributes, path deviation, tracking error, desired velocity, distance to stop, etc.

In various exemplary embodiments, the present disclosure adds functionality and components to the architecture, to carry out domain analysis of the added functionality and to identify models and the usage contexts required and quality attributes for each context. Also, to add the usage contexts and quality attributes to the existing skeleton system available in the architecture.

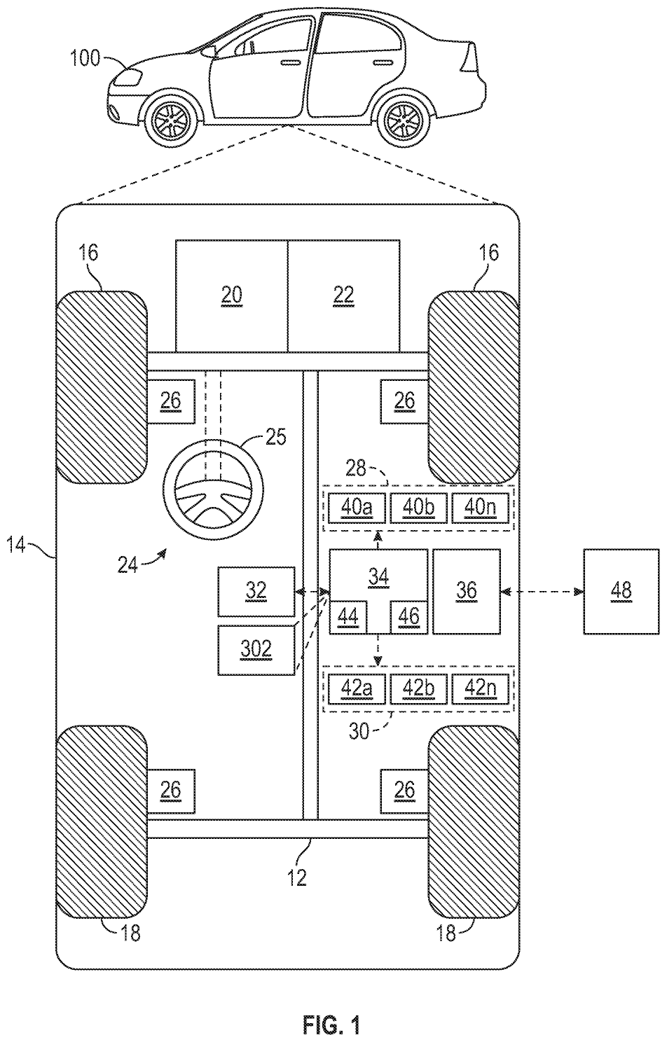

FIG. 1 depicts an example vehicle 100 that includes a controller 302 with a novel architecture that provides integrated lateral and longitudinal controls with adaptable software interfaces and increases in scope, softness, portability, and reusability (hereinafter “integrated motion controller”). As depicted in FIG. 1, the vehicle 100 generally includes a chassis 12, a body 14, front wheels 16, and rear wheels 18. The body 14 is arranged on the chassis 12 and substantially encloses components of the vehicle 100. The body 14 and the chassis 12 may jointly form a frame. The wheels 16-18 are each rotationally coupled to the chassis 12 near a respective corner of the body 14.

In various embodiments, the vehicle 100 may be an autonomous vehicle or a semi-autonomous vehicle. An autonomous vehicle 100 is, for example, a vehicle that is automatically controlled to carry passengers from one location to another. The vehicle 100 is depicted in the illustrated embodiment as a passenger car, but other vehicle types, including motorcycles, trucks, sport utility vehicles (SUVs), recreational vehicles (RVs), marine vessels, aircraft, etc., may also be used.

As shown, the vehicle 100 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel 25 for illustrative purposes, in some embodiments contemplated within the scope of the present disclosure, the steering system 24 may not include a steering wheel.

The sensor system 28 includes one or more sensing devices 40a-42n that sense observable conditions of the exterior environment and/or the interior environment of the vehicle 100 (such as the state of one or more occupants) and generate sensor data relating thereto. Sensing devices 40a-42n might include, but are not limited to, radars (e.g., long-range, medium-range-short range), lidars, global positioning systems, optical cameras (e.g., forward facing, 360-degree, rear-facing, side-facing, stereo, etc.), thermal (e.g., infrared) cameras, ultrasonic sensors, odometry sensors (e.g., encoders) and/or other sensors that might be utilized in connection with systems and methods in accordance with the present subject matter.

The actuator system 30 includes one or more actuator devices 40a-42n that control one or more vehicle features such as, but not limited to, the propulsion system 20, the transmission system 22, the steering system 24, and the brake system 26. In various embodiments, vehicle 100 may also include interior and/or exterior vehicle features not illustrated in FIG. 1, such as various doors, a trunk, and cabin features such as air, music, lighting, touch-screen display components (such as those used in connection with navigation systems), and the like.

The data storage device 32 stores data for use in automatically controlling the vehicle 100. In various embodiments, the data storage device 32 stores defined maps of the navigable environment. In various embodiments, the defined maps may be predefined by and obtained from a remote system. For example, the defined maps may be assembled by the remote system and communicated to the vehicle 100 (wirelessly and/or in a wired manner) and stored in the data storage device 32. Route information may also be stored within the data storage device 32—i.e., a set of road segments (associated geographically with one or more of the defined maps) that together define a route that the user may take to travel from a start location (e.g., the user's current location) to a target location. As will be appreciated, the data storage device 32 may be part of the controller 34, separate from the controller 34, or part of the controller 34 and part of a separate system.

The controller 34 includes at least one processor 44 and a computer-readable storage device or media 46. The processor 44 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 100. In various embodiments, controller 34 is configured to implement a mapping system as discussed in detail below.

The instructions may include one or more separate programs, each of which includes an ordered listing of executable instructions for implementing logical functions. The instructions, when executed by the processor 44, receive and process signals (e.g., sensor data) from the sensor system 28, perform logic, calculations, methods and/or algorithms for automatically controlling the components of the vehicle 100, and generate control signals that are transmitted to the actuator system 30 to automatically control the components of the vehicle 100 based on the logic, calculations, methods, and/or algorithms. Although only one controller 34 is shown in FIG. 1, embodiments of the vehicle 100 may include any number of controllers 34 that communicate over any suitable communication medium or a combination of communication mediums and that cooperate to process the sensor signals, perform logic, calculations, methods, and/or algorithms, and generate control signals to automatically control features of the vehicle 100.

The communication system 36 is configured to wirelessly communicate information to and from other entities 48, such as but not limited to, other vehicles (“V2V” communication), infrastructure (“V2I” communication), networks (“V2N” communication), pedestrian (“V2P” communication), remote transportation systems, and/or user devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

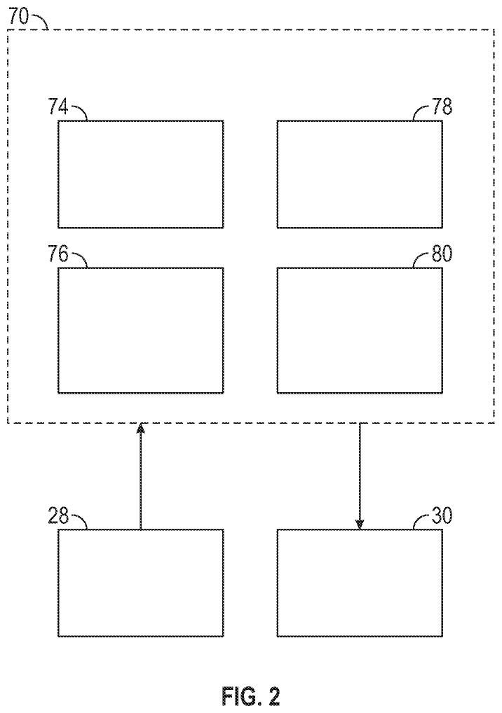

In accordance with various embodiments, controller 34 may implement an autonomous driving system (ADS) 70 as shown in FIG. 2. That is, suitable software and/or hardware components of controller 34 (e.g., processor 44 and computer-readable storage device 46) may be utilized to provide an autonomous driving system 70 that is used in conjunction with vehicle 100.

In various embodiments, the instructions of the autonomous driving system 70 may be organized by function or system. For example, as shown in FIG. 2, the autonomous driving system 70 can include a perception system 74, a positioning system 76, a path planning system 78, and a vehicle control system 80. As can be appreciated, in various embodiments, the instructions may be organized into any number of systems (e.g., combined, further partitioned, etc.) as the disclosure is not limited to the present examples.

In various embodiments, the perception system 74 synthesizes and processes the acquired sensor data and predicts the presence, location, classification, and/or path of objects and features of the environment of the vehicle 100. In various embodiments, the perception system 74 can incorporate information from multiple sensors (e.g., the sensor system 28), including but not limited to cameras, lidars, radars, and/or any number of other types of sensors. In various embodiments, all or parts of the radar detections may be included within the perception system 74.

The positioning system 76 processes sensor data along with other data to determine a position (e.g., a local position relative to a map, an exact position relative to a lane of a road, a vehicle heading, etc.) of the vehicle 100 relative to the environment. As can be appreciated, a variety of techniques may be employed to accomplish this localization, including, for example, simultaneous localization and mapping (SLAM), particle filters, Kalman filters, Bayesian filters, and the like.

The path planning system 78 processes sensor data along with other data to determine a path for the vehicle 100 to follow. The vehicle control system 80 generates control signals for controlling the vehicle 100 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

In various embodiments, the positioning system 76 is configured to determine where the vehicle 100 is located or positioned within the grid (i.e. occupancy grid), and the dynamic object detections determine where moving objects are located relative to the vehicle 100 within the grid (not shown). Sensor input from the sensing devices 40a-40n may be processed by the (i.e. integrated motion) controller 302 for lateral and longitudinal control. Also, in some embodiments, the vehicle positioning system 76 and/or the path planning system 78 communicate with the other entities to determine the relative positions of the vehicle 100 and the surrounding vehicles, pedestrians, cyclists, and other dynamic objects.

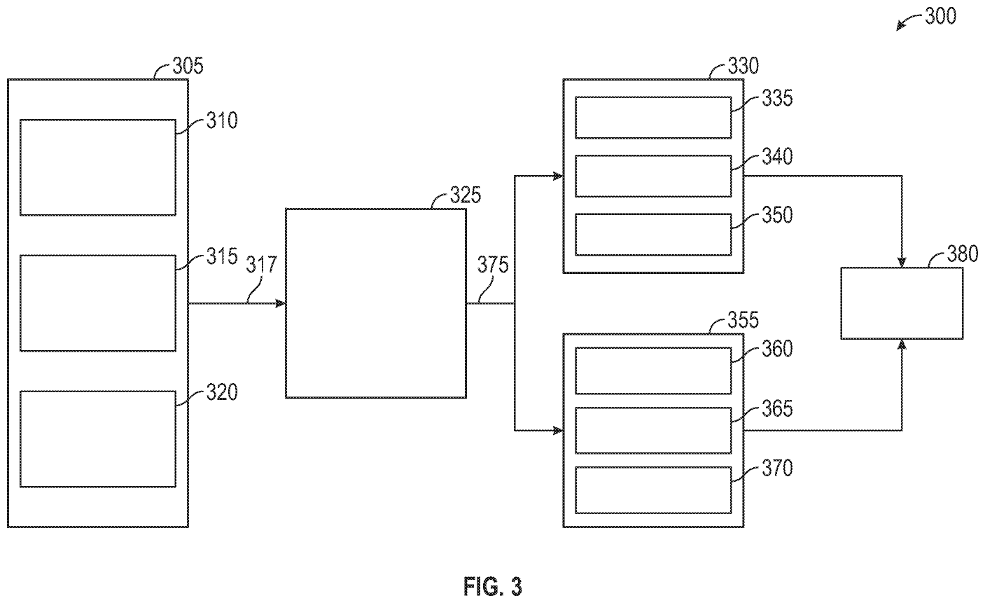

FIG. 3 is an adaptable skeleton constructs and model components depicting an example (i.e. integrated motion) controller 302 for providing lateral and longitudinal control, in accordance with an embodiment. The example controller 302 is configured to apply one or more skeleton constructs to add to various usage contexts and for enabling software scalability.

In FIG. 3 there is shown a functional architecture 300 of the controller 302 with inputs 305 of data from the lane data process 310, data of the trajectory and road from an external processor 315, and position data from an IMU 320. This input data 317 is sent to a path reconciliation, diagnostic, and autonomous mode override control 325 processor for initiating a path reconciliation and diagnostic mode for switching controls (i.e. changing selected constructs) via path 375 to a group of lateral controls 330 consisting of lateral control 1 (335), lateral control 2 (340), and lateral control 3 (350) and to a group of longitudinal controls 355 consisting of longitudinal control 1 (360), longitudinal control 2 (365), and longitudinal control 3 (370) and subsequently sent to a various vehicle interfaces 380 for control operations to be executed.

The path reconciliation, diagnostic, and autonomous mode override control 325 switches between different control approaches for autonomous driving in different conditions. That is, the path reconciliation, diagnostic, and autonomous mode override control 325 switches between the lateral control 330 and the longitudinal control 355 based on the environmental condition based on the data from the lane data process 310, the trajectory and road data for the external processor 315 and the position data from the IMU 320. The path reconciliation, diagnostic, and autonomous mode override control 325 facilitates the switching between a speed based or range based longitudinal control and switching between low, high path deviation lateral maneuvers without modification to the software. Each of the lateral controls (i.e. lateral control 1, 2, and 3) is configured with a respective low speed, high speed or low/high path deviation construct. Similarly is true for the longitudinal control (i.e. longitudinal control 1, 2 and 3) which is configured with a respective speed control and range control construct.

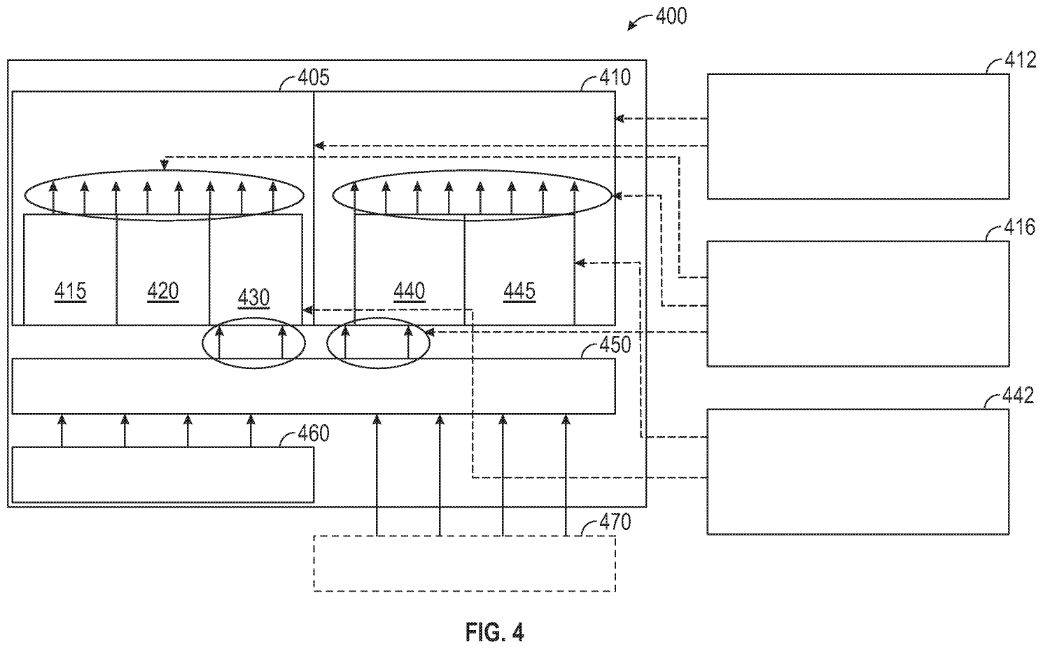

Referring to FIG. 4, the example adaptable skeleton constructs and model components diagram 400 includes a lateral control 405, and a longitudinal control 410. The lateral control 405 and longitudinal control 410 are model variants 412 that are library references that enable reusability and portability. In addition, the adaptable skeleton constructs and model components diagram 400 includes lateral control 405 of low speed 415, high speed 420, and low/high path deviation 430, and the longitudinal control 410 includes speed control 440 and range control 445. The low speed 415, high speed 420, low/high path deviation 430, speed control 440, and range control 445 are skeleton constructs that can be used to add any other usage contexts and enable software scalability. The adaptive path reconstruction 450 enables selection of the skeleton constructs (i.e. the set of constructs of low speed 415, high speed 420, low/high path deviation 430, speed control 440, and range control 445) for different control designs for usage context while considering memory restraints. This results in the best performance of the lateral controls 405 and the longitudinal control 410 in different usage contexts (e.g. for low and high-speed contexts for lateral control, and range and speed based contexts for longitudinal control). The adaptive path reconstruction 450 achieves usage contexts by following the desired path from an internal processor (i.e. internal path planner 460) or an external processor 470. Additionally, the skeleton constructs (i.e. the set of constructs of low speed 415, high speed 420, low/high path deviation 430, speed control 440, and range control 445) can be added for any usage context and enable scalability. In instances, the external processor 470 can add quality attributes for each construct of the set of constructs of the low speed 415, high speed 420, low/high path deviation 430, speed control 440, and range control 445 constructs, individual or in combination as desired.

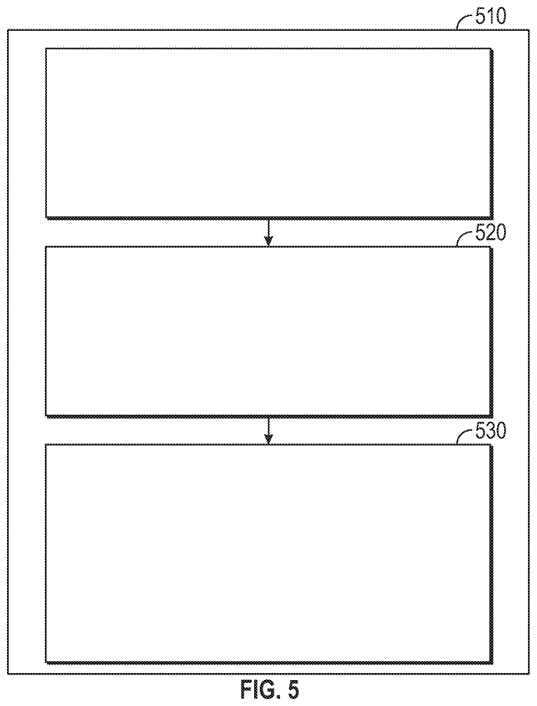

FIG. 5 illustrates a diagram of pseudo code for the operation of a controller or path planner in accordance with an embodiment. In Block 510, the pseudo code for a controller selection is depicted. In this case, the logic of the pseudo-code describes a speed controller selection scenario. Here, if the stopping distance is less than a sum of a threshold, and an acceleration in a linear direction from a linear quadratic (LQ) speed controller, and the sum is greater than acceleration in the linear direction desired from an operation of a speed controller (i.e. a pure pursuit speed controller) then the pure pursuit controller is enabled. In the alternative or else, another controller is enabled, that is then the LQ speed controller control is enabled. Next, Block 520 depicts pseudo range and speed controller arbitration. In this case, if a range (detected from vehicle data) is less than a sum of a threshold and linear acceleration (Ax) desired from a speed controller and the sum is also greater than greater than the linear acceleration desired from the range controller; then, in this case, the range controller is enabled. In the alternated, another controller is enabled: else, the speed controller is enabled. Block 530 depicts pseudo path selection if the external path is valid, then is path validation data is passed through as inputs (i.e. received by the adaptive path reconstruction module) else if the internal map is valid, then the path is generated internally else if camera data is valid, then the path is generated from the camera data else (e.g. if none of these conditions exist) then the autonomous controls are disabled.

In various exemplary embodiments, the configuration outputs from the selection of the constructs can be illustrated from generating a path from an external processor and induce faults in the external path. If the trajectory inputs to low-level controls are different from the outputs from the external path then the software will use the architecture of constructs as described.

Alternately, the configuration can be determined by generating a path from an external processor, query the number of outputs from external path planner, number of outputs from internal path planner and number of path planning signals at the input side of low-level control. If the path planner signals at low-level control input are equal to one of the internal or external path planner outputs this implies that the architecture is as described.

Further, if the design follows a breakdown of software in terms of usage contexts then the architecture is configured as described.

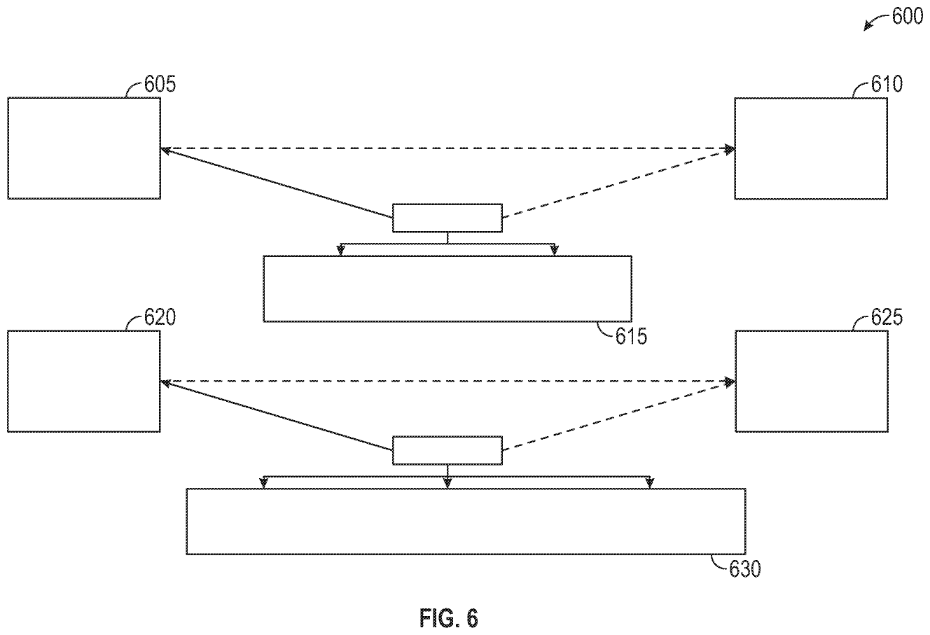

FIG. 6 illustrates a diagram of domain analysis to identify features and systems in accordance with an embodiment. In FIG. 6, the domain analysis in a first manner is based on a model of longitudinal control 605 with features from constructs of range and speed control 615 executed by systems of pursuit control and LQ control 610. The domain analysis to identify features and systems in a second manner is based on the model of lateral control 620 and features of constructs of low speed, high speed and low/high path deviation maneuvers 630 executed by systems of non-linear parabolic fit 625.

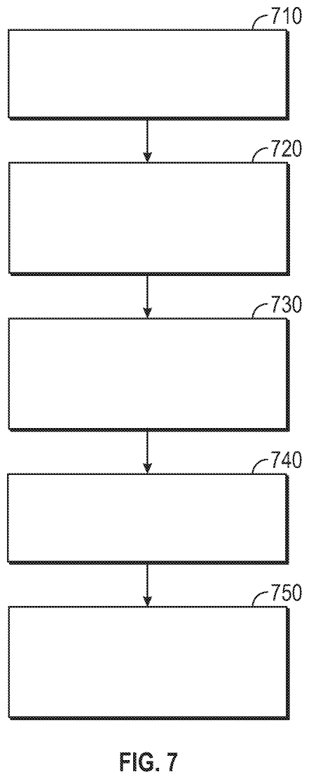

In the flowchart of FIG. 7, in step 710 data from a lane data process, data from an external processors about vehicle trajectory and road information and positional data (IMU data) are received by a path reconciliation diagnostic autonomous mode override system to override the current control configuration to switch between groups of lateral controls and longitudinal controls for autonomous driving in different environments. At 720, an adaptable skeleton of constructs is configured for a particular lateral and longitudinal controls together for model variants that enable reusability and portability. At 730, the lateral control is composed of constructs of low speed, high speed, and low/high path deviation constructs, and the longitudinal control is composed of constructs of speed control and range control. Further, an adaptive path reconstruction for selecting various constructs with the adaptable interfaces and quality attributes that reduce computational time constraint and help achieve faster throughput. At step 740, the skeleton constructs are configured to add other usage contexts and enable software scalability. By the different configurations, different usage contexts can be provided and the reconstruction of the controls to vehicle interfaces from the path planner to the controller can be configured based on path validity. This achieves best performance of lateral and longitudinal controls in different usage contexts and enables switching between different variants which reduces the memory space needed.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. Various changes can be made in the function and arrangement of elements without departing from the scope of the disclosure as set forth in the appended claims and the legal equivalents thereof.

As an example, the apparatus, systems, methods, techniques, and articles described herein may be applied to measurement systems other than radar systems. The apparatus, systems, methods, techniques, and articles described herein may be applied to velocity measurement sensors such as laser or light-based velocity measurement sensors.

What is claimed is:

1. A system for motion control for an autonomous vehicle by implementing an adaptive skeleton construct interface with different models, comprising:
a first model that comprises: a lateral controller to implement selective lateral controls by an adaptive path reconstruction module to select constructs for lateral control from a set of a plurality of constructs which at least comprise: a low speed construct, a high speed construct and a low and high path deviation;
a second model that comprises: a longitudinal controller to implement selective longitudinal controls by an adaptive path reconstruction module to select constructs for longitudinal control from a set of a plurality of constructs which at least comprise: a speed control construct, and a range control construct;
a path reconciling module for reconciling a path based on vehicle data to validate a path for operation and for implementing one or more of the lateral or longitudinal controls without having to re-create another lateral control or longitudinal control, by selecting one or more from an already created set of lateral or longitudinal controls for use wherein the vehicle data at least comprises: lane, trajectory, and position vehicle data; and
one or more vehicle interfaces for receiving controls from the one or more already created set of lateral or longitudinal controls.

2. The system of claim 1, further comprising:
the one or more sets of the plurality of constructs implemented with usage context in the lateral and longitudinal control.

3. The system of claim 1 wherein the path reconciling module comprises: an internal and external path generating module.

4. The system of claim 1, further comprising:
the first and second models comprise library references for at least re-usability.

5. The system of claim 1, wherein the set of constructs are configured in adaptable interfaces for different usage contexts extracted from an analysis of an autonomous driving domain.

6. The system of claim 1, wherein the speed and range control construct comprises:
one or more different control designs for usage.

7. The system of claim 1, further comprising:
the first and second model is configured to:
implement one or more different controls for switching between each different control thereby reducing memory usage and throughput while processing.

8. A method for implementing lateral and longitudinal controls by using an adaptive construct with model for an autonomous vehicle, the method comprising:
configuring an external processor for generating vehicle data comprising: at least trajectory and road data for initiating a path reconciliation and diagnostic override mode of the autonomous vehicle;
configuring an adaptive path reconstruction processor to receive the vehicle data to implement a first model of a lateral control by selecting one or more constructs for lateral control from a set of a plurality of lateral constructs which comprise: a low speed construct, a high speed construct and a low and high path deviation construct;
configuring the adaptive path reconstruction processor to receive the vehicle data to implement a second model of a longitudinal control by selecting one or more constructs for longitudinal control from a set of a plurality of longitudinal constructs which comprise:
a speed control construct, and a range control constructs; and
reconciling, by the adaptive path reconstruction module, both an internal path generating module and an external path generating module by configuring a path using selective constructs of the first and second models for lateral and longitudinal vehicle control without having to re-create models for the reconciled path.

9. The method of claim 8, further comprising:
configuring, by the adaptive path reconstruction module, one or more constructs of the first and second model to include vehicle usage context for the lateral and longitudinal control of the autonomous vehicle.

10. The method of claim 9, wherein the vehicle usage context comprises: low speed, high speed, and high/low path deviation maneuvers.

11. The method of claim 8, further comprising:
implementing the first and second models with library references that enable re-usability and portability.

12. The method of claim 8, wherein the constructs have adaptable interfaces for different usage contexts derived from the autonomous driving domain analysis.

13. The method of claim 8, wherein the speed and range control constructs comprise:
different control designs implemented for different usages.

14. The method of claim 8, further comprising:
switching between different models of the first and second model to implement one or more different controls/functions to reduce memory and throughput while achieving better control performance.

15. An apparatus with a skeleton construct for implementing lateral and longitudinal controls by an adaptive construct with models for implementing path planning in an autonomous vehicle, the apparatus comprises:
an external processor for generating at least vehicle data comprising trajectory and road data for initiating a path reconciliation and diagnostic override mode of the autonomous vehicle;
an adaptive path reconstruction processor to receive the vehicle data to implement a first model of a lateral control by selecting one or more constructs for lateral control from a set of a plurality of lateral constructs which comprise: a low speed construct, a high speed construct and a low and high path deviation construct;
the adaptive path reconstruction processor to receive the vehicle data to implement a second model of a longitudinal control by selecting one or more constructs for longitudinal control from a set of a plurality of longitudinal constructs which comprise: a speed control construct, and a range control construct; and
the adaptive path reconstruction module reconciling both an internal path generating module and an external path generating module by configuring a path using selective constructs of the first and second model for lateral and longitudinal vehicle control without having to re-create models for the reconciled path.

16. The apparatus of claim 15, further comprising:
adaptive path reconstruction module to implement one or more constructs of the first and second models to include vehicle usage context for the lateral and longitudinal control of the autonomous vehicle.

17. The apparatus of claim 16, wherein the vehicle usage context comprises: low speed, high speed, and high/low path deviation maneuvers.

18. The apparatus of claim 15, further comprising:
the first and second models implemented with library references that at least enable re-usability.

19. The apparatus of claim 15, wherein the constructs comprise: adaptable controls configured for vehicle interfaces for different usage contexts derived from analysis of an autonomous driving domain.

20. The apparatus of claim 15, wherein the speed and range control constructs comprise: different control designs implemented for different usages.
